(19) United States
(12) Patent Application Publication
(10) Pub. No.: US 2019/0118347 A1
(43) Pub. Date: Apr. 25, 2019

(54) REPLACEMENT STRUCTRE OF PAIR OF PLIERS

(71) Applicant: MIN-ZHENG ZENG, Nantou City (TW)

(72) Inventor: MIN-ZHENG ZENG, Nantou City (TW)

(21) Appl. No.: 15/791,310

(22) Filed: Oct. 23, 2017

(51) Int. Cl. B25B 7/04; B25B 7/08; B25B 7/14

(52) U.S. Cl. CPC B25B 7/04; B25B 7/14; B25B 7/08

(57) ABSTRACT

A replacement structure of a pair of pliers contains: a first grip, a second grip, multiple screw bolts, and a first plier set and a second plier set which are alternatively rotatably connected with the first grip and the second grip. The first grip includes a first connection disc having multiple first orifices, and the second grip includes a second connection disc having multiple second orifices. The first plier set includes a first clamp arm and a second clamp arm, the first clamp arm has multiple third orifices, and the second clamp arm has multiple fourth orifices. Alternatively, when the second plier set is rotatably connected with the first grip and the second griping, the second plier set includes a third clamp arm and a fourth clamp arm, the third clamp arm has multiple fifth orifices, and the fourth clamp arm has multiple sixth orifices.

### FIELD OF THE INVENTION

The present invention relates to a replacement structure of a pair of pliers which selects a first plier set or a second plier set to clamp/unclamp a workpiece based on using requirements.

### BACKGROUND OF THE INVENTION

A conventional pair of pliers is used to clamp or unclamp a workpiece by expanding or retracting two grips thereof in a fixed distance. However, such a conventional pair of pliers cannot select a first plier set or a second plier set to clamp/unclamp a workpiece based on using requirements.

The present invention has arisen to mitigate and/or obviate the afore-described disadvantages.

### SUMMARY OF THE INVENTION

The primary aspect of the present invention is to provide a replacement structure of a pair of pliers which selects a first plier set or a second plier set to clamp/unclamp a workpiece based on using requirements.

To obtain the above mentioned aspect, a replacement structure of a pair of pliers provided by the present invention contains: a first grip, a second grip, multiple screw bolts, and a first plier set and a second plier set which are alternatively rotatably connected with the first grip and the second grip.

The first grip includes a first connection disc formed on a top of the first grip, the second grip includes a second connection disc arranged on a top of the second grip and rotatably connecting with the first connection disc, wherein the first connection disc has multiple first orifices defined thereon, and the second connection disc has multiple second orifices formed thereon.

When the first plier set is rotatably connected with the first grip and the second griping, the first plier set includes a first clamp arm and a second clamp arm, the first clamp arm has multiple third orifices formed on a bottom thereof and corresponding to the multiple first orifices respectively, and the second clamp arm has multiple fourth orifices defined on a bottom thereof and corresponding to the multiple second orifices individually, such that some of the multiple screw bolts screw the first clamp arm with the first grip via the multiple third orifices and the multiple first orifices respectively, and the other screw bolts screw the second clamp arm with the second grip via the multiple fourth orifices and the multiple second orifices respectively so that when the first grip and the second grip are pressed, the first clamp arm and the second clamp arm move close to each other.

Alternatively, when the second plier set is rotatably connected with the first grip and the second griping, the second plier set includes a third clamp arm and a fourth clamp arm, the third clamp arm has multiple fifth orifices formed on a bottom thereof and corresponding to the multiple first orifices respectively, and the fourth clamp arm has multiple sixth orifices defined on a bottom thereof and corresponding to the multiple second orifices individually, such that some of the multiple screw bolts screw the third clamp arm with the first grip via the multiple fifth orifices and the multiple first orifices respectively, and the other screw bolts screw the fourth clamp arm with the second grip via the multiple sixth orifices and the multiple second orifices respectively so that when the first grip and the second grip are pressed, the third clamp arm and the fourth clamp arm move away from each other.

Preferably, an arcuate toothed extension is rotatably coupled with an inner wall of the first grip and inserts through a fixing ring of the second grip, and the arcuate toothed extension has multiple teeth for limiting an expansion between the first grip and the second grip, and a spring is defined between the first grip and the second grip; the arcuate toothed extension has an operation element formed on one end thereof and configured to control the multiple teeth to movably retain with and remove from the fixing ring of the second grip.

### BRIEF DESCRIPTION OF THE DRAWINGS

FIG. 1 is a perspective view showing the exploded components of a replacement structure of a pair of pliers according to a preferred embodiment of the present invention.

FIG. 2 is another perspective view showing the exploded components of the replacement structure of the pair of pliers according to the preferred embodiment of the present invention.

FIG. 3 is a side plan view showing the operation of the replacement structure of the pair of pliers according to the preferred embodiment of the present invention.

FIG. 4 is another side plan view showing the operation of the replacement structure of the pair of pliers according to the preferred embodiment of the present invention.

FIG. 5 is also another side plan view showing the operation of the replacement structure of the pair of pliers according to the preferred embodiment of the present invention.

FIG. 6 is still another side plan view showing the operation of the replacement structure of the pair of pliers according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

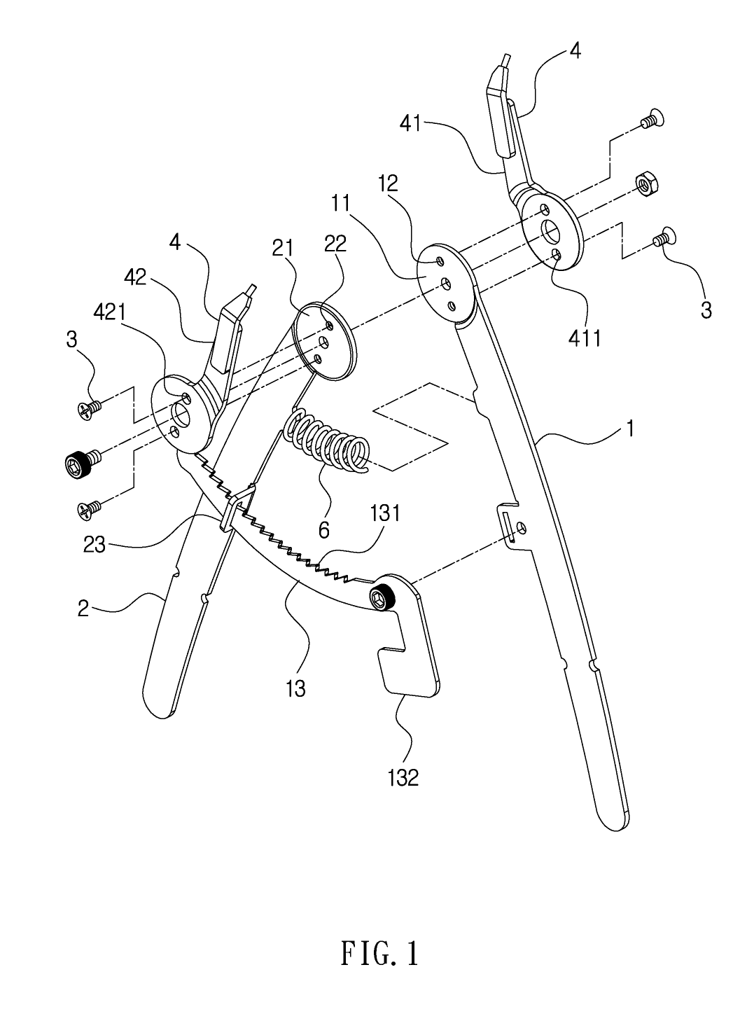

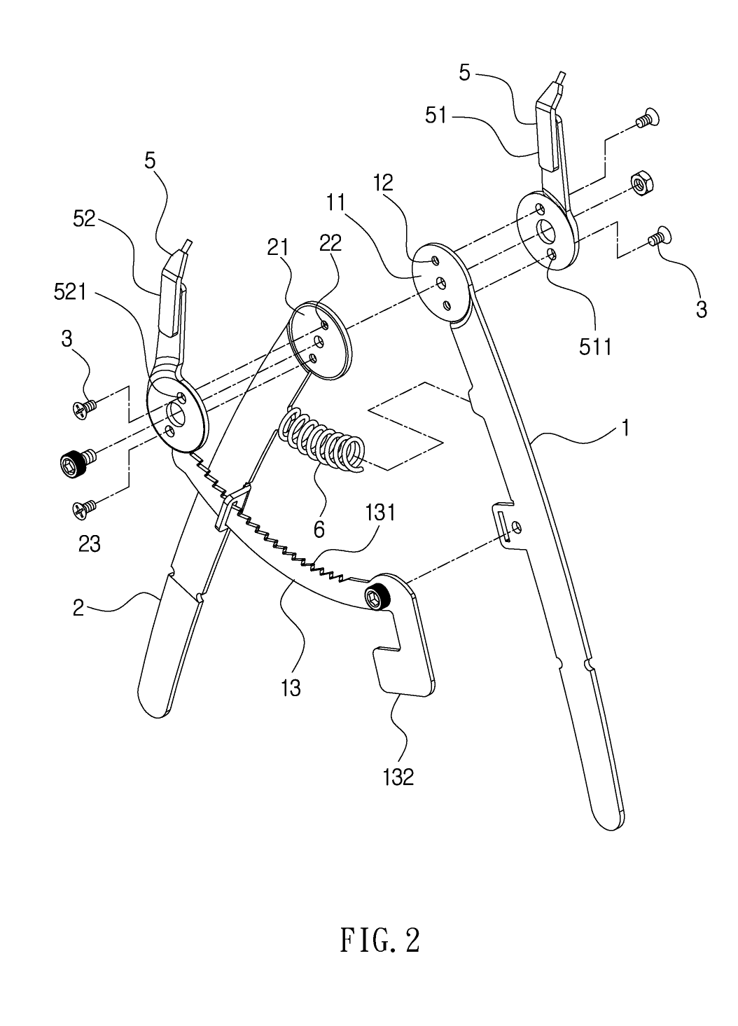

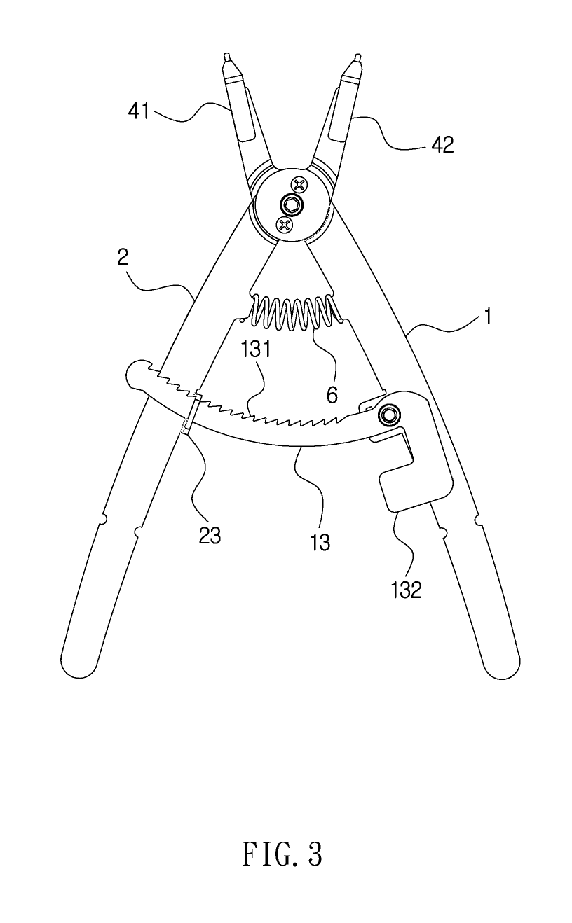

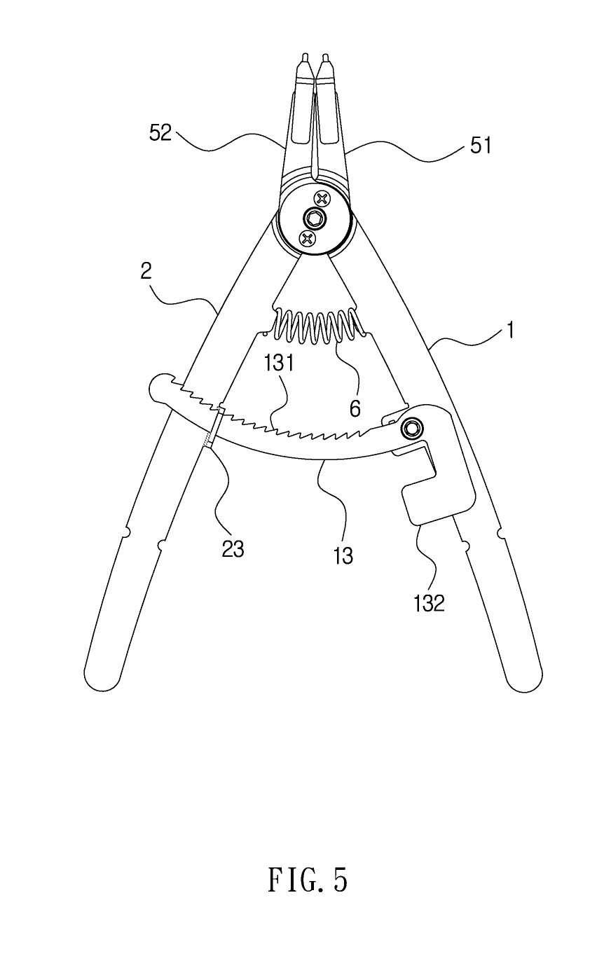

With reference to FIGS. 1-6, a replacement structure of a pair of pliers in accordance with a preferred embodiment of the present invention comprises: a first grip 1, a second grip 2, multiple screw bolts 3, and a first plier set 4 and a second plier set 5 which are alternatively rotatably connected with the first grip 1 and the second grip 2.

The first grip 1 includes a first connection disc 11 formed on a top thereof, the second grip 2 includes a second connection disc 21 arranged on a top thereof and rotatably connecting with the first connection disc 11, wherein the first connection disc 11 has multiple first orifices 12 defined thereon, and the second connection disc 21 has multiple second orifices 22 formed thereon.

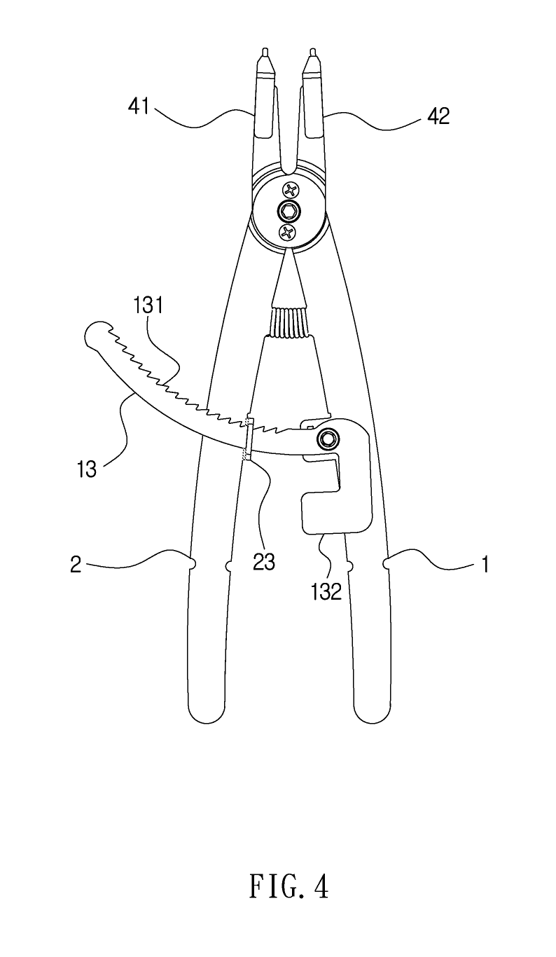

The first plier set 4 includes a first clamp arm 41 and a second clamp arm 42, the first clamp arm 41 has multiple third orifices 411 formed on a bottom thereof and corresponding to the multiple first orifices 12 respectively, and the second clamp arm 42 has multiple fourth orifices 421 defined on a bottom thereof and corresponding to the multiple second orifices 22 individually, such that some of the multiple screw bolts 3 screw the first clamp arm 41 with the first grip 1 via the multiple third orifices 411 and the multiple first orifices 12 respectively, and the other screw bolts 3 screw the second clamp arm 42 with the second grip 2 via the multiple fourth orifices 421 and the multiple second orifices 22 respectively so that when the first grip 1 and the second grip 2 are pressed, the first clamp arm 41 and the second clamp arm 42 move close to each other, as shown in FIG. 4.

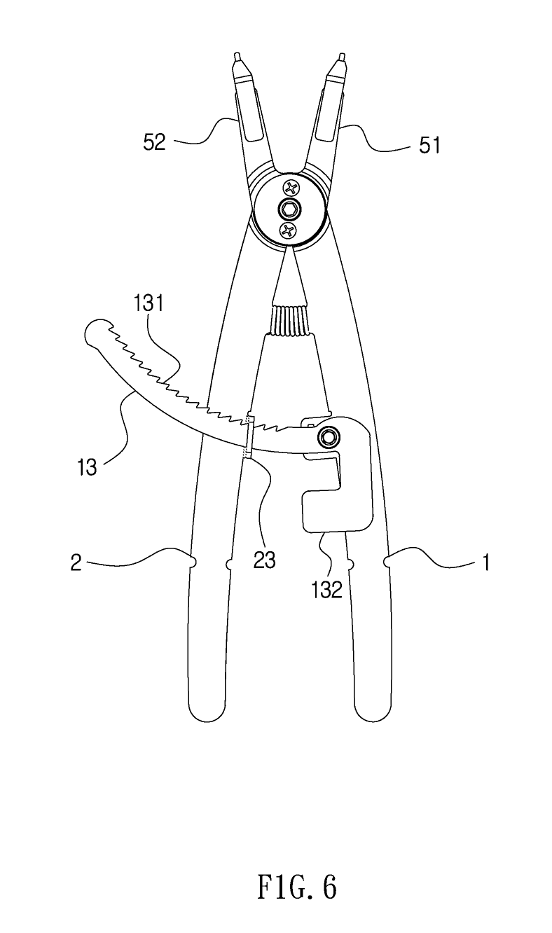

The second plier set 5 includes a third clamp arm 51 and a fourth clamp arm 52, the third clamp arm 51 has multiple fifth orifices 511 formed on a bottom thereof and corresponding to the multiple first orifices 12 respectively, and the fourth clamp arm 52 has multiple sixth orifices 521 defined on a bottom thereof and corresponding to the multiple second orifices 22 individually, such that the multiple screw bolts 3 screw the third clamp arm 51 with the first grip 1 via the multiple fifth orifices 511 and the multiple first orifices 12 respectively, and the multiple screw bolts 3 screw the fourth clamp arm 52 with the second grip 2 via the multiple sixth orifices 521 and the multiple second orifices 22 respectively so that when the first grip 1 and the second grip 2 are pressed, the third clamp arm 51 and the fourth clamp arm 52 move away from each other, as shown in FIG. 6.

Thereby, when first plier set 4 is rotatably connected with the first grip 1 and the second grip 2, the pair of pliers are applied to clamp a workpiece, and when the second plier set 5 is rotatably connected with the first grip 1 and the second grip 2, the pair of pliers are applied to unclamp a workpiece.

An arcuate toothed extension 13 is rotatably coupled with an inner wall of the first grip 1 and inserts through a fixing ring 23 of the second grip 2, wherein the arcuate toothed extension 13 has multiple teeth 131 for limiting an expansion between the first grip 1 and the second grip 2, and a spring 6 is defined between the first grip 1 and the second grip 2. The arcuate toothed extension 13 has an operation element 132 formed on one end thereof and configured to control the multiple teeth 131 to movably retain with and remove from the fixing ring 23 of the second grip 2, thus moving the first clamp arm 41/the third clamp arm 51 close to/away from the second clamp arm 42/the fourth clamp arm 52.

Accordingly, the replacement structure of the pair of pliers are capable of selecting the first plier set or the second plier set to clamp/unclamp the workpiece based on using requirements.

While various embodiments in accordance with the present invention have been shown and described, it is clear to those skilled in the art that further embodiments may be made without departing from the scope of the present invention.

What is claimed is:

1. A replacement structure of a pair of pliers comprising: a first grip, a second grip, multiple screw bolts, and a first plier set and a second plier set which are alternatively rotatably connected with the first grip and the second grip;
the first grip including a first connection disc formed on a top of the first grip, the second grip including a second connection disc arranged on a top of the second grip and rotatably connecting with the first connection disc, wherein the first connection disc has multiple first orifices defined thereon, and the second connection disc has multiple second orifices formed thereon;
wherein when the first plier set is rotatably connected with the first grip and the second griping, the first plier set includes a first clamp arm and a second clamp arm, the first clamp arm has multiple third orifices formed on a bottom thereof and corresponding to the multiple first orifices respectively, and the second clamp arm has multiple fourth orifices defined on a bottom thereof and corresponding to the multiple second orifices individually, such that some of the multiple screw bolts screw the first clamp arm with the first grip via the multiple third orifices and the multiple first orifices respectively, and the other screw bolts screw the second clamp arm with the second grip via the multiple fourth orifices and the multiple second orifices respectively so that when the first grip and the second grip are pressed, the first clamp arm and the second clamp arm move close to each other;
wherein when the second plier set is rotatably connected with the first grip and the second griping, the second plier set includes a third clamp arm and a fourth clamp arm, the third clamp arm has multiple fifth orifices formed on a bottom thereof and corresponding to the multiple first orifices respectively, and the fourth clamp arm has multiple sixth orifices defined on a bottom thereof and corresponding to the multiple second orifices individually, such that some of the multiple screw bolts screw the third clamp arm with the first grip via the multiple fifth orifices and the multiple first orifices respectively, and the other screw bolts screw the fourth clamp arm with the second grip via the multiple sixth orifices and the multiple second orifices respectively so that when the first grip and the second grip are pressed, the third clamp arm and the fourth clamp arm move away from each other.

4. The replacement structure of the pair of pliers as claimed in claim 1, wherein an arcuate toothed extension is rotatably coupled with an inner wall of the first grip and inserts through a fixing ring of the second grip, and the arcuate toothed extension has multiple teeth for limiting an expansion between the first grip and the second grip, and a spring is defined between the first grip and the second grip; the arcuate toothed extension has an operation element formed on one end thereof and configured to control the multiple teeth to movably retain with and remove from the fixing ring of the second grip.
